(19) United States
(12) Patent Application Publication
(10) Pub. No.: US 2009/0147791 A1
(43) Pub. Date: Jun. 11, 2009

(54) IP NETWORK SERVICE QUALITY MANAGEMENT BY DISTRIBUTED ADMISSION CONTROL BASED ON A SIGNALLING PROTOCOL

(75) Inventors: Roland Schutz, Gometz Le Chatel (FR); Dominique Billonneau, St Pryve St Mesmin (FR); Denis Gourlaouen, La Garenne Colombes (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/574,009

(22) PCT Filed: Aug. 18, 2005
(86) PCT No.: PCT/EP05/54075

§ 371 Date: Feb. 20, 2009

(30) Foreign Application Priority Data
Aug. 20, 2004 (FR) 04 09027

(51) Int. Cl. H04L 12/56

(52) U.S. Cl. 370/395.21

(57) ABSTRACT

Procedure and device for managing the quality of service hop-by-hop in a packet-based communications network comprising several arteries linked together by a router, the network supporting a signalling protocol. The procedure comprises at least at each router a step of reserving the resources on the arteries gradually and a step ensuring once the communication has been established that the packets of one and the same connection follow the path between the sending source and the destination on which the resources have been reserved.

### CROSS-REFERENCE TO RELATED APPLICATIONS

The present Application is based on International Application No. PCT/EP2005/054075, filed on Aug. 18, 2005, which in turn corresponds to French Application No. 0409027, filed on Aug. 20, 2004, and priority is hereby claimed under 35 USC §119 based on these applications. Each of these applications are hereby incorporated by reference in their entirety into the present application.

### FIELD OF THE INVENTION

The invention relates to a procedure and a device making it possible to manage service quality hop-by-hop within a communications network comprising several arteries linked together by a routing device for example.

### BACKGROUND OF THE INVENTION

The invention applies in respect of multimedia stream transport on a meshed network based on the IP protocol (Internet Protocol).

### SUMMARY OF THE INVENTION

In certain telecommunication networks, the management of service quality at a global level, differentiated or Diffserv services, is not sufficient. It turns out also to be necessary to dynamically manage connection-oriented streams each having specific quality of service (QoS) parameters such as precedence, latency time, jitter, loss sensitivity, bandwidth.

For each of these streams, it is necessary to manage:
The admission control for connections with a signaling protocol,
The routing of the streams in a meshed network according to the availability of the resources in the network,
The control of the sending of the user data in accordance with the reservations previously performed.

Stream-based management of quality of service is based mainly on the mechanisms for reserving resources which take account of the quality of service or QoS parameters. The reservation of the resources is based on signaling protocols (H.323 or SIP).

DiffServ offers three classes of service:
The service class corresponding to the maximum priority which makes it possible to minimize the delay and its variation for real-time traffic or Expedited Forwarding (EF) is assumed to be used for multimedia and video services requiring real-time capabilities (latency time, jitter).
The service class which allows the transmission of the data without taking account of the latencies or of the variations in delay or Assured Forwarding (AF) is assumed to be used for the data services which demand bandwidth guarantees (bandwidth, low losses).
The low priority or Best Effort (BE) service class which is used for the services not having any bandwidth, latency time or jitter constraint.

The DiffServ model has not standardized any signaling protocol, to avoid the storage of contexts in the routers. This model has been developed by the IETF to solve the switchover to Internet scale. The DiffServ model has been specified for telecommunications network operators. This model requires a scheduling of the network corresponding to the level of service required by the users connected to the network. This model operates correctly if the core of the network has sufficient resources and if these resources are correctly scheduled. Generally, the network resources are explicitly reserved by the operator for the network established for its client. In the case of applications having global mobility constraints and/or constraints of resources present in the core of the network that are below the global requirements, the scheduling of resources is no longer possible.

For these cases, it turns out useful:
to reserve resources forming part of a Service class for the time of a communication. This reservation is performed with a signaling protocol.
to supply these resources to the system when the communication is terminated, typical case is speech communication.

The procedure according to the invention relies notably on the following principles:
the reservation of resources is managed by a connections admission control mechanism, which controls the establishment of the streams according to: the type of communication, the resources available and also the precedence of the communication.
because of the frequent changes of topology of the network, the connections admission control (CAC) is present in each node of the network and therefore is distributed over the network. The CAC function, as in a connection-oriented network, reserves the resources gradually during the establishment of the connection. These resources are reserved on the communication support arteries.
a specific routing protocol can be developed to take account of the evolution of the reservation of resources on the arteries of the network core (QoS routing, flooding route search, etc.).
once the communication has been established the procedure ensures that all the packets of one and the same connection follow the route on which the resources have been reserved for this communication.

The invention relates to a procedure for managing the quality of service hop-by-hop in a packet-based communications network comprising several arteries linked together by a router, the network supporting a signaling protocol, characterized in that it comprises at least at each router a step of reserving the resources on the arteries hop-by-hop and a step ensuring once the communication has been established that the packets of one and the same connection follow the path between the sending source and the destination on which the resources have been reserved.

The resource reservations are for example performed during the propagation of the network core signaling.

The procedure can comprise the following steps:
Establish and release, dynamically, circuits required either by the application package level, or by a user,
Reserve the resources on the arteries for each established circuit; with each reservation is associated the bandwidth, the precedence of the reservation, and the service class which encompasses this resource,
Ensure the preemption of a communication, if there are not sufficient resources available for a new communication having a higher priority level.
   The routing is for example based:
either on the trunking table present in the routers
or on an application package level routing protocol.

The procedure for example uses an IP network.

The invention also relates to a device for managing the quality of service hop-by-hop in a communications network comprising several arteries linked together by means of a router, and a signaling protocol, characterized in that each router or node of the network comprises a means suitable for reserving the resources gradually and a means suitable for guaranteeing that the packets of one and the same communication follow the same route on which the signaling protocol has previously reserved the resources for the communication.

The device for example comprises means suitable for:
establishing and releasing in a dynamic manner the circuits required either by the application package level, or by a user,
routing the communications according to trunking tables (present in the router or formulated by a routing protocol taking account of the reservations performed),
reserving the resources on the arteries for each established circuit; and associating with each reservation the bandwidth, the precedence of the reservation, and the service class which encompasses this resource,
managing the preemption of a communication if there are not sufficient resources available for a new communication having a higher priority level.

The network is for example a meshed network based on the IP protocol.

The invention also relates to a component for managing the quality of service within a communications network comprising several arteries, comprising at least the following elements:
an interface for configuring the system,
an interface for managing the arteries,
a resources manager,
a stack of signaling protocols,
an integrated routing protocol,
a module for controlling the resources manager.

The invention has in particular the following advantages:

It makes it possible in particular to control the state of the resource reservations of an artery on a telecommunications network before propagating the call which is the subject of a multimedia communication, for example. The control being carried out at each hop at the level of each artery of a meshed network, the quality of service of the multimedia communication can, in this way, be guaranteed end-to-end.

The type of organization according to the invention offers the advantage of operating when the bandwidth available on the arteries of the network is low, since it allows the implementation of connections admission control mechanisms on the arteries of the communications network.

The organization also makes it possible to ensure that the packets of one and the same communication all follow the same route on which the signaling protocol has previously reserved the resources for the communication, while the IP routing can designate other optimal routes.

The system which is the subject of the present invention also allows the reservation of network resources for the OODA (or Observe Orient Decide and Act) loops of NCW (Network Centric Warfare) applications.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 a functional chart of the procedure according to the invention,

FIG. 2 a general chart presenting the various issues dealt with by the procedure according to the invention,

FIG. 3 an exemplary architecture of a communications network using the procedure.

### DETAILED DESCRIPTION OF THE INVENTION

In order to better elucidate the invention, the description which follows given by way of wholly nonlimiting illustration relates to a telecommunications network using the Diffserv model combined with a signaling protocol making it possible to control the network resources.

Hop-by-hop routing can be likened to the creation of a circuit network in parallel or overlay on a datagram network core. The overlay circuit operates on a set of private links installed in a shared operator infrastructure, for example.

The circuits are established dynamically with a signaling protocol, such as H.323 or SIP developed by international bodies. The circuit establishment request is made by the user who requires an application package circuit for a given stream (example: speech stream, videoconferencing, etc.). The establishment of the circuit is managed by a local server LCC (Local Call Control, H.323 Gatekeeper, SIP server).

The network core signaling is also based on the ITU or IETF standards (H.323, SIP). This signaling propagates in the network core the requirement of the user or of the application. The resource reservations are performed gradually during this propagation.

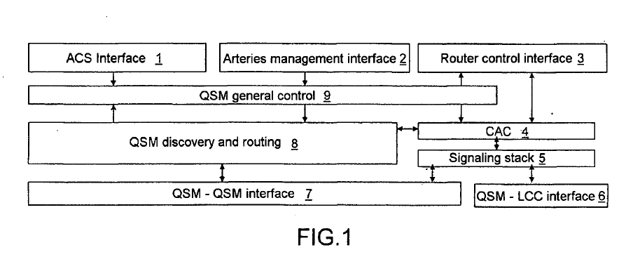

FIG. 1 shows diagrammatically a functional chart of a component for managing the quality of service according to the invention. It comprises for example:
An interface for configuring the system or ACS 1;
An interface for managing the arteries 2;
An interface for controlling the router 3;
A resources manager or CAC having in particular as functions: the connection, the admission, the allocation of the resources with the passage of time, and the management of the preemptions of the communications 4;
A stack of signaling protocols 5;
An interface with the user signaling (LCC) 6;
An interface with the network signaling (QSM) 7;
An integrated routing protocol 8;
A general control module for the QSM resources manager 9.

The general control module 9 is in particular charged with the distribution of the artery level information (state, topology, bandwidth, etc.) to the internal QSM modules (routing, CAC management). This module is also charged with the reconfiguration of the queues of the router, if the bandwidth available on the link changes.

The CAC module 4 stores the resources reservation performed during the establishment of the circuits. For each reservation, this module stores the bandwidth reservation, the precedence and also the service class (EF, AF1, AF2). These parameters are used to perform the admission control for the new connections.

The CAC module formulates a calculation of average latency for the communication. If this latency exceeds an admissible maximum for the communication, the admission control rejects the communication (for example, in the case where there are more than 2 satellite hops for a telephone call). The latency of the communication is the sum of all the latencies of the communication (compression, latencies of the arteries, buffering).

The routing and discovery module 8 might not be present according to the protocols used. In this case, the QSM module reads the routing table to obtain the route or routes to the destination server (LCC) and propagates the connection request on this route.

The signaling stack 5 takes into account the access protocol managed by the LCC and manages the signaling protocols propagated on the network. These protocols comply with the standards established by the ITU and the IETF. Complementary information, necessary for the establishment of the communication, is transported in a user to user information element (UUIE), for example, the destination server address, the precedence of the communication, the average latency on the route, etc.

Functionally, the procedure according to the invention operates in the following manner. The procedure ensures:
Dynamically the establishment and the releasing of the circuits required either by the application package level, or by a user (telephony, for example);
The reservation of resources on the arteries for each established circuit; with each reservation is associated the bandwidth, the precedence of the reservation, and the service class which encompasses this resource,
The preemption of a communication, if there are not sufficient resources available for a new communication having a higher priority level,
The routes making it possible to reach the destination LCC server in charge of the communication; the routing can be based:
   Either on the trunking table present in the routers, in this case, the establishment is dispatched to the destination server (LCC) according to the optimal route formulated by the router's routing protocol, in the event of equivalent routes, it is possible to explore alternative routes,
   Or on an application package level routing protocol (QoS routing, flooding route search, etc.)
The successive packets of one and the same stream are trunked on the same arteries, even when the topology of the network changes.

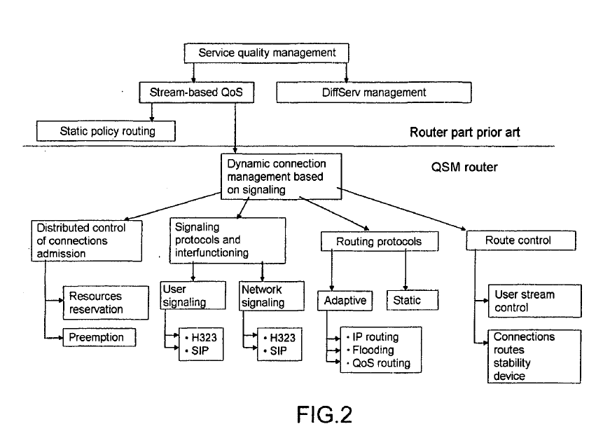

FIG. 2 shows diagrammatically a chart comprising in its upper part, the actions managed conventionally by a router according to the prior art and in its lower part the various issues dealt with by the procedure according to the invention designated QSM.

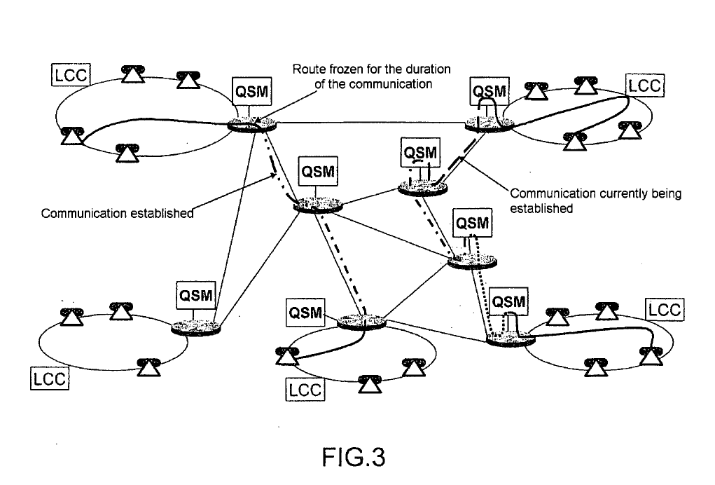

FIG. 3 represents an exemplary implementation of the procedure within a network comprising several QSM routers according to the invention. The routers are linked by arteries. A router is connected to an LCC destination server.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for managing the quality of service hop-by-hop in a packet-based communications network comprising several arteries linked together by a router, the network supporting a signaling protocol, comprising at each router the following steps:
dynamically the establishment and the releasing of the circuits required either by the application package level, or by a user,
the reservation of resources on the arteries for each established circuit; with each reservation is associated the bandwidth, the precedence of the reservation, and the service class which encompasses this resource,
the preemption of a communication, if there are not sufficient resources available for a new communication having a higher priority level.

2. The method as claimed in claim 1, wherein the resource reservations are performed during the propagation of the network core signaling.

3. The method as claimed in claim 2, wherein the routing is based:
either on the trunking table present in the routers
or on an application package level routing protocol.

4. The method as claimed in claim 1, wherein it uses an IP network.

5. A device for managing the quality of service hop-by-hop in a communications network comprising several arteries linked together by means of a router, and a signaling protocol, wherein each router or node of the network comprises a means suitable for:
establishing and releasing in a dynamic manner the circuits required either by the application package level, or by a user;
routing the communications according to trunking tables,
reserving the resources on the arteries for each established circuit; and associating with each reservation the bandwidth, the precedence of the reservation, and the service class which encompasses this resource,
managing the preemption of a communication if there are not sufficient resources available for a new communication having a higher priority level.

6. The device as claimed in claim 5, wherein the network is a meshed network based on the IP protocol.

7. A component for managing the quality of service within a communications network comprising several arteries according to a method of claim 1, comprising at least the following elements:
an interface for configuring the system,
an interface for managing the arteries,
a resources manager,
a stack of signaling protocols,
an interface with the user signaling,
an interface with the network signaling,
an integrated routing protocol,
a module for controlling the resources manager.
